(19) United States
(12) Patent Application Publication
(10) Pub. No.: US 2023/0128257 A1
(43) Pub. Date: Apr. 27, 2023

(54) Combined Tea Making Apparatus

(71) Applicant: WUYISHAN HONGTAI BAMBOO & WOOD PRODUCTS CO., LTD, Fujian (CN)

(72) Inventor: Weixin XU, FUJIAN (CN)

(21) Appl. No.: 17/506,715

(22) Filed: Oct. 21, 2021

(51) Int. Cl. A47J 31/20; A47J 45/06; A47J 31/06; A47J 31/44; A47G 19/14; A47G 19/16

(52) U.S. Cl. CPC A47J 31/20; A47J 45/067; A47J 31/0626; A47J 31/4407; A47J 31/446; A47G 19/14; A47G 19/16

(57) ABSTRACT

The invention presented is a combined tea making apparatus, including teapot and tea filtering bodies; the teapot body has a body and handle, the center connection between body and handle is the first articulation attachment point; two cone projections are set horizontally opposite under the inner edge of the teapot body opening; the two curved grooves on the outside edge of the tea filtering body fit the teapot main body's cone projections. The center points of the cone projections are on the same vertical surface as the first articulation point, allowing tea pouring and filtering without touching the lid. The teapot handle of the teapot, makes it easy to operate with one hand, simplifying tea making and avoiding burn injuries caused by touching. The teapot and tea filtering bodies can both be rotated through 360°, enabling users to enjoy the tea making process, and avoiding scalding hands on the teapot.

### TECHNICAL FIELD

The invention presented relates to tea utensils, especially to a combined tea brewing utensil.

### TECHNICAL BACKGROUND

Many parts of China have a strong tea culture, and the traditional tea brewing process involves a number of steps, such as placing the tea, washing the tea, steeping the tea, dividing the tea, etc. The utensils to be used are teapots, tea filters, tea mugs, teacups, etc. Because of the many steps and the use of a large number of utensils, the waiting time is long. Presently, many teacups, cup lids and filter chambers assembled into a single cup are widely used to simplify the tea making steps, however, in order to avoid the tea being too strong, the filter chambers need to be taken out when drinking, which is inconvenient due to the high water temperature, and the process of taking out and putting in the filter chambers may bring about contamination.

### CONTENT OF THE INVENTION

The purpose of the invention presented is to provide a combined tea making apparatus with an integrated design of teapot body and tea filtering body to realize the process of pouring and filtering tea without touching the cup lid and which can be easily operated with one hand, thus simplifying the steps of tea making and avoiding scalding or damage to hands by the tea apparatus.

In order to achieve the above purpose, the invention presented provides the following technical solutions:

A combined tea making apparatus, including an upward opening teapot body and a tea filtering body; the said teapot body includes a teapot body and a teapot handle, the said teapot handle is permanently fixed to the outer bottom of the edge of the opening of the said teapot body; the center point of the connection between the said teapot body and the said teapot handle is the first articulation attachment point; two cone projections are set horizontally opposite to each other under the inner side of the edge of the opening of said teapot body. The said tea filtering body includes a edge of the tea filtering body and a tea filtering body, the said tea filtering body is provided with two horizontally opposed arc-shaped curved grooves on the outer side, the said arc-shaped curved grooves of the tea filtering body are adapted to the conical projections of said teapot body, the said tea filtering body is placed on the conical projections of said teapot body through linear contact of the arc-shaped grooves; the center points of the two said conical projections and said first articulation point are in the same vertical plane; said teapot body is freely turned with respect to said tea filtering body on the axis of the line between the center points of the two cone projections.

Further, the said teapot body is provided with a spout, the said spout has water flowing out in a direction perpendicular to the line between the center points of the two said cone projections.

Further, the said teapot handle is a cylindrical handle, wherein one end of the cylindrical handle is permanently fixed to the outer side of the teapot body.

Further, the said conical projection is integrally formed with the said teapot body.

Further, the said combined tea making apparatus also comprises of a lid, the said lid being over the upper opening of the tea filtering body.

Further, the said tea filtering body is provided with a tea strainer for filtering tea leaves.

Further, the said tea strainer is a tea strainer with a dominant hole or a tea strainer with a hidden hole.

Further, the said tea filtering body is provided with an opening at the bottom for placing the tea strainer.

Further, the said teapot body is bowl-shaped with an opening above and said tea filtering body is bowl-shaped with an opening above.

Further, the volume of said tea filtering body is smaller than the volume of said teapot body.

Further, the diameter of the outer edge of the rim of said tea filtering body is greater than the distance between the two cone projections.

Further, the distance between the center point of said cone projection and the edge of the opening of said teapot body is 3 mm to 10 mm.

Further, the height of the horizontal surface where the center points of two said arc-shaped curved surface grooves are located is greater than the height of the horizontal surface where the center of said tea filtering body is located.

Analysis shows that the invention presented discloses a combined tea making apparatus, with a teapot body and tea filtering body integrated design, two cone projections are set horizontally opposite to each other on the inner side of the teapot, the tea filtering body corresponding to the cone projection is set horizontally opposite to the outer edge of the arc-shaped curved groove, the suspension design is with only two contact points, suspending the tea filtering body in the teapot, when the cone projection rotates with the teapot body, the cone projection can roll on the curved surface of the curved groove, allowing the tea filtering body to maintain a horizontal level and filter out the brewed tea. This makes it possible to pour and filter tea without touching the lid, and the teapot is equipped with a teapot handle on the outside of the teapot, which makes it easy for the user to operate with one hand, simplifying the tea making steps and avoiding scalding hands and damage to the tea set. In addition, the teapot body and the filtered tea can be rotated 360° relative to each other, allowing user to enjoy the fun of operation while making tea and avoiding direct hand contact with the teapot surface to prevent scalding.

### SPECIFICATION OF DRAWINGS

A specification accompanying the drawings forming part of this application is used to provide a further understanding of the invention, and the schematic embodiments of the invention and their descriptions are used to explain the invention and do not constitute an undue limitation of the invention. Among them:

FIG. 1 is a schematic diagram of the structure of each individual part of the combined tea making apparatus of the invention presented.

FIG. 2 is a schematic diagram of the structure of the combined tea-making apparatus of the invention presented.

FIG. 3 is a schematic diagram of the structure of the tea filtering body in the combined tea making apparatus of the invention presented.

FIG. 4 is a schematic diagram of the structure of the tea filtering body in the combined tea brewing apparatus of the invention presented.

FIG. 5 is an axonometric diagram of the teapot body in the combined tea-making apparatus of the invention presented.

FIG. 6 is a top view of the teapot body in the combined tea-making apparatus of the invention presented.

FIG. 7 is a state diagram of the teapot body and the tea filter body of the combined tea making apparatus without rotation.

FIG. 8 is a state diagram of the teapot body and the tea filtering body of the combined tea making apparatus rotated by 45° relative to each other.

FIG. 9 is a state diagram of the teapot body of the combined tea-making apparatus and the tea filtering body rotated by 90° relative to each other.

FIG. 10 is a state diagram of the teapot body of the combined tea-making apparatus and the tea filtering body rotated 135° relative to each other.

FIG. 11 is a state diagram of the teapot body of the combined tea-making apparatus and the tea filtering body rotated 180° relative to each other.

FIG. 12 is a state diagram of the teapot body of the combined tea-making apparatus and the tea filtering body rotated 225° relative to each other.

FIG. 13 is a state diagram of the teapot body of the combined tea-making apparatus and the tea filtering body rotated 270° relative to each other.

FIG. 14 is a state diagram of the teapot body of the combined tea-making apparatus and the tea filtering body rotated 315° relative to each other.

FIG. 15 is a schematic diagram of the position and structure of the tea strainer in the tea filtering body of the combined tea making apparatus.

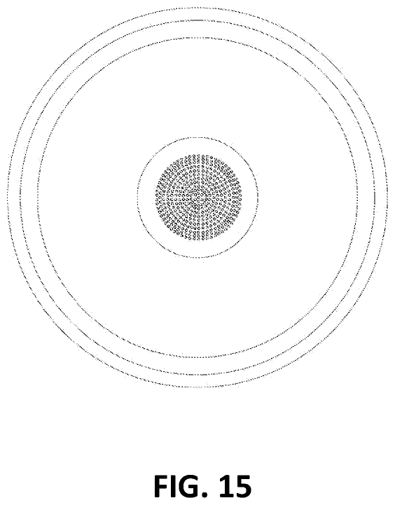

Description of the attached markings: 1—teapot body; 2—tea filtering body; 3—pot lid; 4—first articulation point; 5, 6—center points; 11—teapot body; 12—spout; 14—teapot handle; 15—edge of the opening; 21—edge of tea filtering body; 22—tea filtering body; 24—tea strainer; 131, 132—cone projections; 231, 232—arc-shaped curved grooves.

### SPECIFIC IMPLEMENTATION

The invention presented will be described in detail below with reference to the accompanying drawings and in conjunction with embodiments. The individual examples are provided by way of explanation of the invention presented and are not intended to limit the invention presented. Indeed, it will be clear to those skilled in the art that modifications and variations may be made in the invention presented without departing from the scope or spirit of the invention presented. For example, features shown or described as part of one embodiment may be used in another embodiment to produce yet another embodiment. Thus, it is desired that the invention presented encompass such modifications and variations that are subsumed within the scope of the appended claims and their equivalents.

In the description of the invention, the terms “longitudinal”, “lateral”, “up”, “down”, “front”, “back”, “left”, “right”, “vertical”, “horizontal”, “top”, “bottom”, etc. are used to indicate orientation or positional relationships based on those shown in the accompanying drawings and are intended only to facilitate the description of the invention rather than requiring that the invention must be constructed and operated in a particular orientation, and therefore is not to be construed as a limitation of the invention. The terms “joint”, “connected” and “set” used in the invention presented should be understood in a broad sense, for example, they can be fixed connections or detachable connections; they can be directly connected or indirectly connected through intermediate components; they can be wired electrical connections, radio connections or wireless communication signal connections, and the specific meaning of the above terms can be understood by a person of ordinary skill in the art according to the specific circumstances.

One or more examples of the invention presented are illustrated in the accompanying drawings. The detailed description uses numerical and alphabetical marks to refer to the features in the accompanying drawings. Similar or analogous marks in the accompanying drawings and description have been used to refer to similar or analogous parts of the invention presented. As used herein, the terms “first”, “second” and “third” are used interchangeably to distinguish one member from another and are not intended to indicate the location or importance of separate members. location or importance of the individual members.

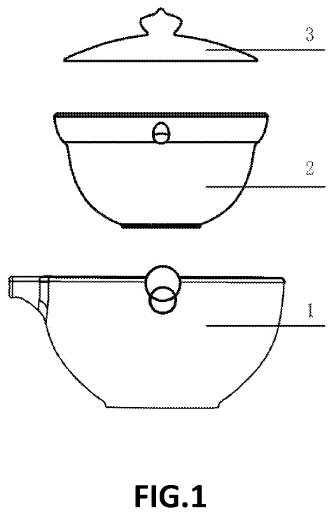

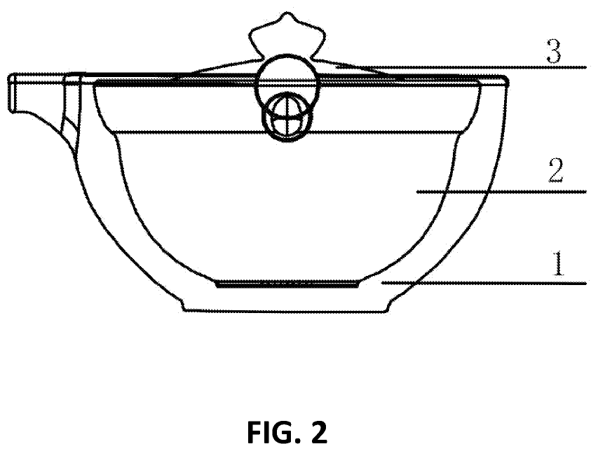

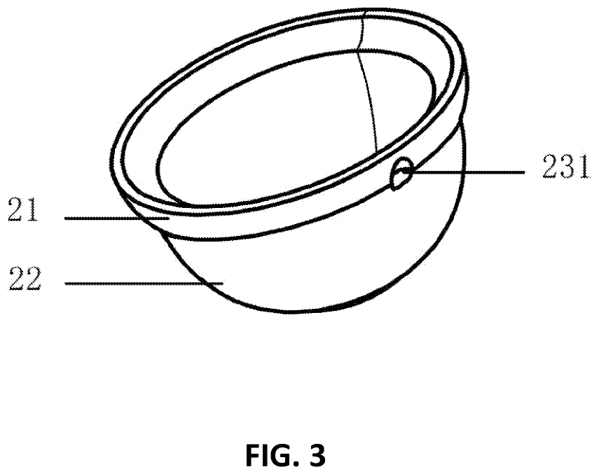

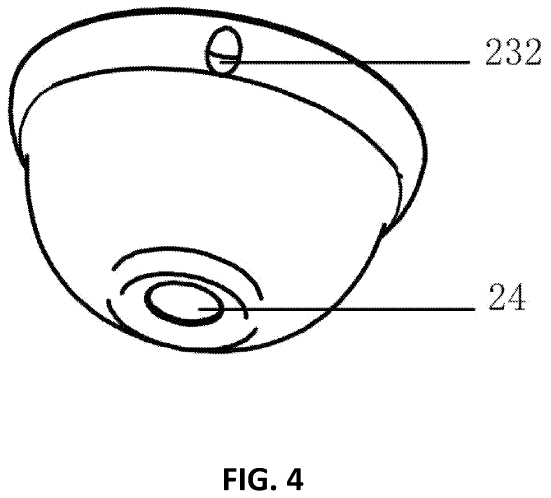

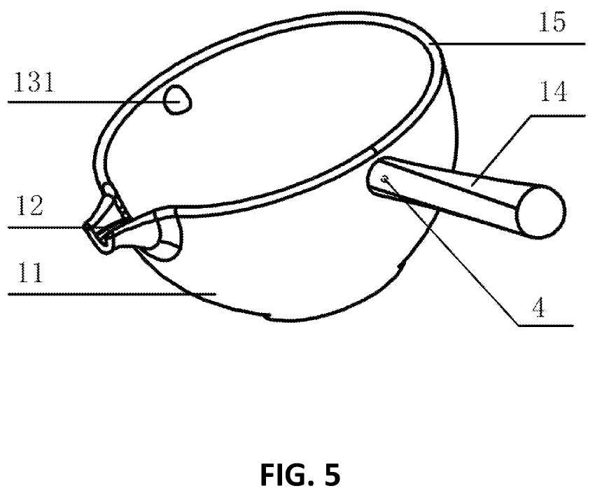

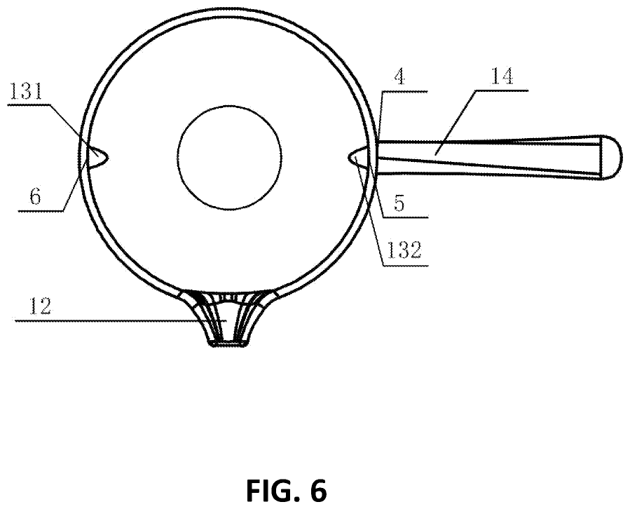

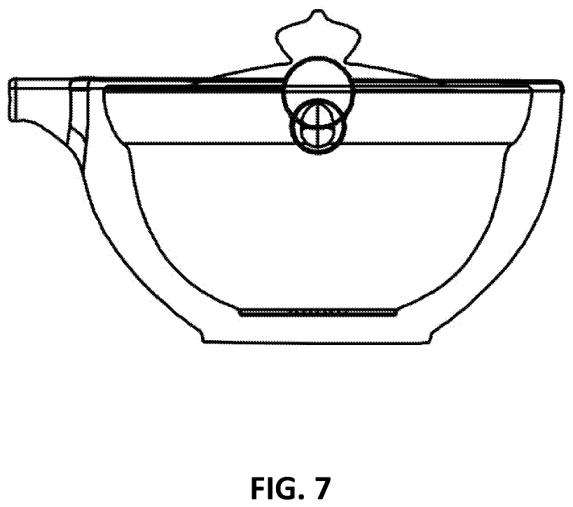

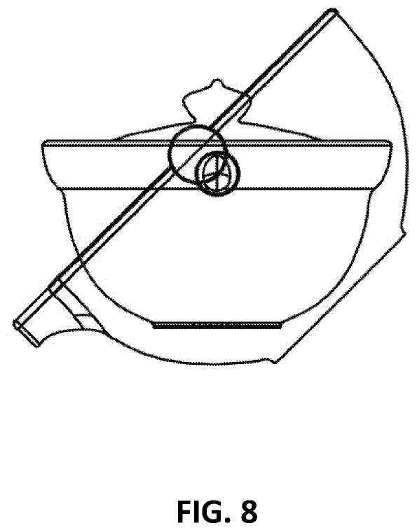

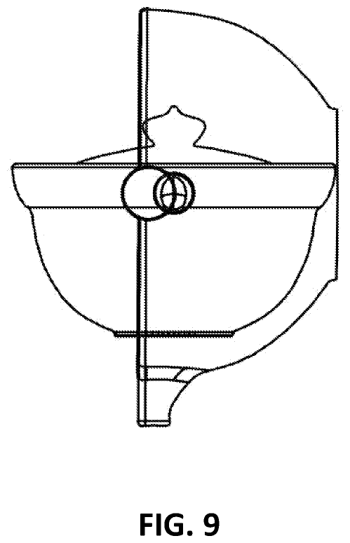

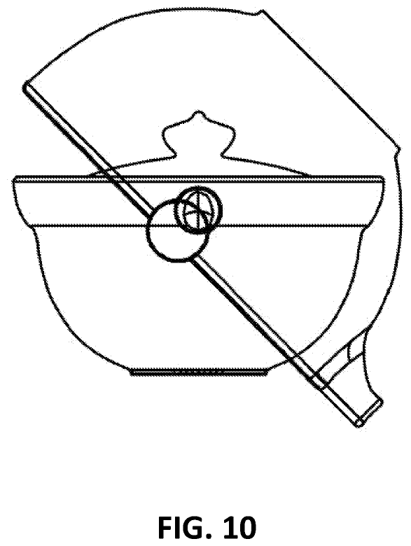

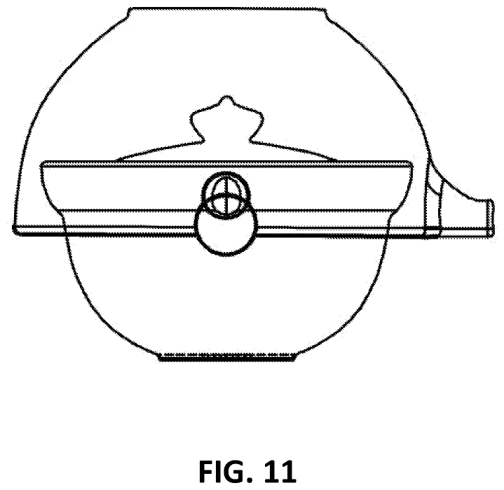

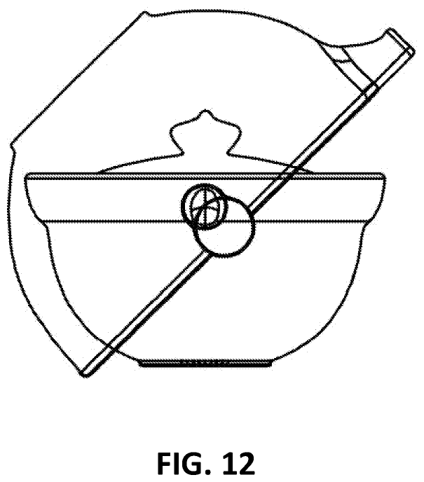

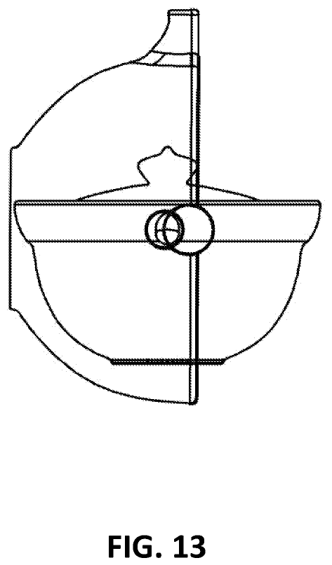

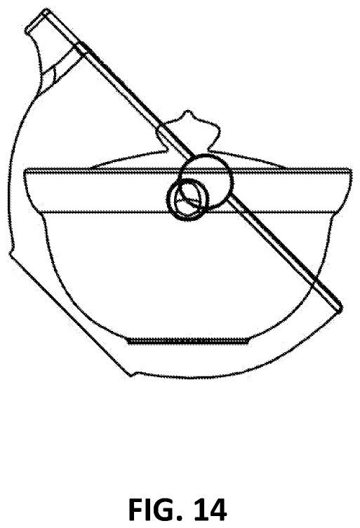

As shown in FIGS. 1 to 14, according to the embodiment of the invention presented, there is provided a combined tea making apparatus comprising an opening-up teapot body 1 and a tea filtering body 2, the teapot body 1 comprising a teapot body 11 and a teapot handle 14, wherein the teapot handle 14 is permanently fixed to the outer side of the teapot body 11 below the edge of the opening 15; the teapot handle 14 is a cylindrical handle, wherein one end of the cylindrical handle is attached to the outer side of the teapot body 11, and the cylindrical handle 14 is a cylindrical handle, wherein one end of the cylindrical handle is permanently fixed to the outer side of the teapot body 11, the cylindrical handle is easy for the user to hold and is convenient for rotating the pot during the process of pouring tea. The center point of the connection between the teapot body 11 and the teapot handle 14 is the first articulation point 4; two cone projections 131, 132 are set horizontally opposite to each other under the inner side of the edge of the opening 15 of the teapot body 11 for hanging the tea filter body 2. In the teapot body 1, the cone projections 131, 132 and the teapot body 11 are made of ceramic and are integrally formed, so there is no need to install cone projections 131, 132 on the inner side of the teapot body 11 again. The tea filtering body 2 includes the edge of the tea filtering body 21 and tea filtering body 22, and the outer side of the edge of the tea filtering body 21 is provided with two horizontally opposed arc-shaped curved surface grooves 231, 232, and the arc-shaped curved surface grooves 231, 232 are adapted to the cone projections 131, 132 of the teapot body 11, and the tea filtering body 2 is placed on the cone projections 131, 132 of the teapot body 11, and the arc curved surface grooves 231, 232 are in linear contact with the cone projections 131, 132, reducing the friction of the contact surface and facilitating the relative rotation between the teapot body 1 and the tea filtering body 2. The tea filtering body 22 is also provided with a tea strainer 24 for filtering tea leave residue, which facilitates the separation of tea leaves from the tea and makes the brewed tea taste better after filtering out the fine tea residue.

The center points 5 and 6 of the two cone projections 131 and 132 are on the same vertical plane as the first articulation point 4, and the teapot body 11 is freely turned 360° outside the tea filter body 2 with the line between the center points of the two cone projections 131 and 132 as the axis. The tea filtering body 2 is suspended in the center of the teapot body 1 to avoid collision between the teapot body 11 and the tea filtering body 22 during the turn of the teapot body 1. Except for the linear contact between the arc-shaped curved grooves 231, 232 and the conical projections 131, 132, the tea filter body 2 has no contact on the inside when the teapot body 1 is freely turned 360°.

The teapot body 11 is provided with a spout 12, and the direction of water flowing out of the spout 12 is perpendicular to the line between the center points of the two cone projections 131, 132. The spout 12 is provided on one side of the teapot body 11, and the tea flows out of the spout 12 when the teapot body 1 is rotated relative to the tea filtering body 2.

The combined tea making apparatus also includes a pot lid 3, the pot lid 3 covers the opening above the tea filtering body 2; adding the pot lid is convenient to maintaining the temperature of the tea making water when making the tea, making the tea that is brewed more fragrant.

The bottom of the tea filtering body 22 is provided with an opening for placing the tea strainer 24, which is convenient for the installation and fixing of the tea strainer 24. The tea strainer 24 is in the form of a tea strainer with explicit holes or a tea strainer with hidden holes. The tea strainer with explicit holes is either a metal hole network or a ceramic hole network formed by a plurality of small and evenly distributed holes, which can keep the tea leaves and small residues inside the tea filtering body 22, and filter out the brewed tea without impurities through the tea strainer 24, and the tea leaves are shelved inside the tea filtering body 2, while the tea is automatically filtered into the teapot body 1 by steeping, and the filtered tea is poured out by rotating the teapot body 1 to pour out the filtered tea. Both the tea strainer with explicit holes and the tea strainer with hidden holes can filter out the tea without impurities. The hidden hole tea strainer is a kind of ceramic tea strainer made of alumina ore, and although the surface of the hidden hole tea strainer has no filtering holes visible to the naked eye, there are several tiny holes inside which are invisible to the naked eye. Compared with the tea strainer with explicit holes, the tea strainer with hidden holes is more delicate for the filtration, of the brewed tea, and the tea strainer with hidden holes can also eliminate the bleaching powders and impurities in tap water, while filtering out the tiny residues, reducing the impurities in the brewed tea and making the filtered tea taste more mellow. The tea strainer with explicit holes is not as good at filtering the tiny tea residues, but it is simpler to produce than the tea strainer with hidden holes, and the production cost is a bit lower.

Teapot body 1 and tea filter body 2 are both made of ceramic and have an open bowl on top, wherein the volume of the tea filter body 2 is smaller than the volume of the teapot body 1, and the overall shape of the teapot body 1 and tea filter body 2 is similar, which can simplify the design process to avoid issues with the rotation process in which the teapot body 11 and tea filter body 22 collide and cannot rotate. The outer edge diameter of the edge of the tea filtering body 21 is greater than the distance between the two cone projections 131, 132, allowing the tea filtering body 2 to be placed on the teapot body 1 smoothly without turning, and keeping the tea filtering body 2 stable and unmoving when the teapot body 1 is rotated.

The distance between the center points 5 and 6 of the conical projections 131 and 132 and the edge of the opening 15 of the teapot body 11 is 3 mm˜10 mm, and the height of the horizontal surface where the center points of the two curved grooves 231 and 232 are located is greater than the height of the horizontal surface where the center of gravity of the tea filtering body 2 is located, so that the tea filtering body 2 is kept in a stable state during the process of pouring tea and does not flip over. The cone projections 131, 132 on the teapot, body during rotation and the arc-shaped curved grooves 231, 232 of the tea filtering body keep line contact all the time, while the rotational force of the teapot body is much greater than the frictional force of the line contact between the teapot body 1 and the tea filtering body 2 because of gravity, so when the teapot body 1 is turned over, the tea filtering body 2 can stay immobile on the cone of the teapot.

The working principle of the combined tea making apparatus of the invention presented is that first of all, the cleaned combined tea making apparatus is placed on a flat table, wherein the tea filtering body 2 is adjusted to place the arc-shaped curved grooves 231, 232 corresponding to the cone projections 131, 132 of the main body of the teapot 11. The tea filtering body 2 is placed on the cone projections 131, 132, the tea leaves are put inside the tea filtering body 2, an appropriate amount of hot water is added, and the top of the pot is covered with a lid 3. After the tea leaves in the filtering body 2 are steeped in hot water for a period of time, the tea strainer 24 inside the filtering body 2 can retain the tea leaves inside the filtering body 2 without flowing into the teapot body 1, while the brewed tea will flow into the teapot body 1 through the tea strainer 24, and after standing for a period of time, the teapot handle 14 is held with one hand and slowly twisted to the side of the spout 12 to allow the flow of the brewed tea from the spout 12 into the tea cup, wherein the amount of brewed tea in the teapot body 1 decreases, and the twisting angle is increased until all the tea has been poured out. The teapot body 1 and the tea filter body 2 of the combined tea making apparatus of the invention presented can be rotated 360° relative to each other, so that all the brewed tea can be poured out during use and, allowing you to have some fun during the rotation process.

From the above description, it can be seen that the purpose of the invention presented is to provide a combined tea making apparatus with integrated design of teapot body and tea filtering body, with a cone projection in the teapot body and an arc-shaped curved groove matching the cone projection on the outside of the tea filtering body, suspending the tea filtering body in the teapot body, and when the cone projection rotates with the teapot body, the cone projection can roll on the curved surface of the arc-shaped curved groove, so that the tea filtering body can maintain the horizontal orientation and filter out the brewed tea. The process of pouring and filtering tea is accomplished without touching the lid of the cup, and in addition, the teapot is provided with a teapot handle on the outside of the teapot, which makes it possible for the user to operate it easily with one hand, simplifying the steps of making, tea, and avoiding scalding hands by touching and causing damage to the tea set by scalding.

The above described is only a preferred embodiment of the invention presented, and is not used to limit the invention presented, which can have various changes and variations made by technical persons in the field. Any modification, equivalent replacement, improvement, etc. made within the spirit and principles of the invention presented shall be included in the scope of protection of the invention presented.

1. The utility model relates to a combined tea infuser, which comprises an upturned teapot body and a tea filter body.
The teapot body comprises a teapot main body and a teapot handle; the teapot handle is attached to said teapot body below the outer side of the edge of the opening; said teapot body and said teapot handle are connected to the center point of the first articulation point.
Two conical projections are provided horizontally opposite to each other below the inner side of the open edge of said teapot body.
The said tea filter body comprises a tea filter body edge and a tea filter main body; the said tea filter body edge being provided with two horizontally opposed arc-shaped curved grooves on the outer side, the arc-shaped curved grooves of the said tea filter body being adapted to fit the conical projections of the said teapot main body. The said tea filter body is placed in linear contact with said conical projections of said teapot body. The centers of said two conical projections are on the same vertical plane as said first articulation point; said teapot body is freely turned with respect to said tea filter body on the axis of the line between the centers, of said two conical projections.

2. The combined tea making apparatus according to claim 1, wherein said teapot body is further provided with a water outlet, the direction of water flow from said outlet being perpendicular to the line of connection between the center points of the two said cone projections.

3. The combined tea making apparatus according to claim 1, wherein the said teapot handle is a cylindrical, handle, wherein one end of the cylindrical handle is permanently fixed to the outer side of the teapot body.

4. The combined tea making apparatus according to claim 1, wherein the said conical projections are integrally formed with said teapot body.

5. The combined tea making apparatus according to claim 1, wherein the said combined tea making apparatus further comprises of a pot lid the said pot lid being on top of the upper opening of the tea filtering body.

6. The combined tea making apparatus according to claim 1, wherein the said tea filtering body is further provided with a tea strainer for filtering tea leaves.

7. The combined tea making apparatus according to claim 6, wherein the said tea strainer is a tea strainer with a dominant hole or a tea strainer with a hidden hole.

8. The combined tea making apparatus according to claim 6, wherein the said tea filter body is provided with an opening at the bottom for placing the tea strainer.

9. The combined tea making apparatus according to claim 1, wherein the said teapot body is a bowl-shaped body with an opening at the top, the said tea filter body is a bowl with an opening, at the top.

10. The combined tea making apparatus according to claim 9, wherein the volume of said tea filtering body is smaller than the volume of said teapot body.

11. The combined tea making apparatus according to claim 9, wherein the diameter of the outer edge of said tea filtering body is greater than the distance between the two conical projections.

12. The combined tea making apparatus according to claim 1, wherein the distance between the center points of said cone projections and the edge of the opening of said teapot body is from 3 mm to 10 mm.

13. The combined tea making apparatus according to claim 1, wherein the height of the horizontal surface where the center points of two said curved recesses are located is greater than the height of the horizontal surface where the center of gravity of said tea filter body is located.
